(19) United States
(12) Patent Application Publication
(10) Pub. No.: US 2014/0167940 A1
(43) Pub. Date: Jun. 19, 2014

(54) METHOD OF CONVERTING AUDIO SIGNAL TO HAPTIC SIGNAL AND APPARATUS THEREOF

(71) Applicant: POSTECH ACADEMY - INDUSTRY FOUNDATION, Gyeongbuk (KR)

(72) Inventors: Seung Moon Choi, Pohang-si (KR); Jae Bong Lee, Pohang-si (KR)

(73) Assignee: POSTECH ACADEMY - INDUSTRY FOUNDATION, Gyeongbuk (KR)

(21) Appl. No.: 14/099,759

(22) Filed: Dec. 6, 2013

(30) Foreign Application Priority Data
Dec. 17, 2012 (KR) 10-2012-0147362

(51) Int. Cl. G08B 6/00

(52) U.S. Cl. CPC G08B 6/00
USPC 340/407.1

(57) ABSTRACT

Disclosed are a method and an apparatus of efficiently converting audio signal to haptic signal. A method of converting audio signal into haptic signal, performed in a haptic signal converting apparatus, may include obtaining perceptive characteristic information of the audio signal from the audio signal provided; obtaining perceptive characteristic information of the haptic corresponding to the obtained perceptive characteristic information of the audio signal; and converting the perceptive characteristic information of the haptic into a haptic signal. Thus, the audio signal may be converted to the haptic signal intuitively and in real time, so that the method and the apparatus may be applied to various fields such as a mobile device, a gaming terminal, a home theater, and a 4 dimensional theater system, etc.

### CLAIM FOR PRIORITY

This application claims priority to Korean Patent Application No. 10-2012-0147362 filed on Dec. 17, 2012 in the Korean Intellectual Property Office (KIPO), the entire contents of which are hereby incorporated by reference.

### BACKGROUND OF INVENTION

1. Technical Field

Example embodiments of the present invention relate in general to the field of a signal processing, and more specifically to a method of converting audio signal to haptic signal and an apparatus of performing the same.

2. Related Art

Recently, a haptic technology is being applied to various multimedia contents such as games, movies, music and so on. The systems supporting the haptic technology are already being widely used through various apparatuses like earphones and headphones supporting vibration, a home theater system, a 4 dimensional movie theater, a tangible gaming machine, a smart phone and a tablet, etc.

As described above, the products supporting the haptic technology may provide environments that can immerse users to the multimedia contents. On the other hand, effects customized for a specific content should be produced by experts in order to provide the haptic effects to the users. Thus, much time and cost are needed to produce the haptic effects, and this is becoming a cause of the problem that there are not so many contents which the haptic technology is applied to.

As a solution for resolving the problem, methods of generating haptic effects automatically have been designed. For example, a US published patent application (2011-0128132A1; ‘System and Method for Automatically Producing Haptic Events from A Digital Audio Signal’) discloses a technique related to a method of producing haptic events from digital audio signal. The invention disclosed in the published application includes components of haptic solutions devised by Immersion corp., and these components are applied to some smartphones which are being sold in the market.

However, all the conventional methods of producing haptic effects, including that of the above-mentioned published application, have a limit in the point that they produce the haptic effects based on only signal characteristics of audio signal. That is, since all the conventional haptic effect producing algorithms produce haptic effects based on a low-pass filtering, a band-pass filtering and analysis on spectrum, haptic effects, which will be produced as results, are not easily estimated in designing procedure of converting audio signal into haptic signal.

Therefore, even experts in the field of haptic technology may not easily design an optimal haptic signal converting method by using the conventional haptic signal converting methods, and especially there are many difficulties for persons with less professional knowledge to use corresponding functions intuitively and optimize haptic effects.

### SUMMARY

Accordingly, example embodiments of the present invention are provided to substantially obviate one or more problems due to limitations and disadvantages of the related art.

Example embodiments of the present invention provide a method of converting audio signal to haptic signal, capable of generating haptic effect optimized to perceptive characteristics of human.

Example embodiments of the present invention also provide an apparatus of converting audio signal to haptic signal, capable of performing the method of converting audio signal to haptic signal.

In some example embodiments, a method of converting audio signal into haptic signal, performed in a haptic signal converting apparatus, the method may include obtaining perceptive characteristic information of the audio signal from the audio signal provided; obtaining perceptive characteristic information of the haptic corresponding to the obtained perceptive characteristic information of the audio signal; and converting the perceptive characteristic information of the haptic into a haptic signal.

Here, the perceptive characteristic information of the audio signal may include at least one of a loudness, a roughness, a smoothness, a consonance, and a brightness.

Here, the obtaining perceptive characteristic information of the haptic may include defining a relation between the perceptive characteristics of the audio signal and the perceptive characteristics of the haptic; and obtaining the perceptive characteristic information of the haptic corresponding to the perceptive characteristics of the audio signal by using the defined relation.

Here, the perceptive characteristic information of the haptic may include at least one of an intensity, a roughness, a consonance, a level of the haptic, and an uniformity corresponding to the perceptive characteristic information of the audio signal.

Here, the perceptive characteristic information of the haptic is characterized by that a user interface for being provided with parameters to adjust perceptive characteristic of the haptic may be provided, and the perceptive characteristic information of the haptic may be obtained by reflecting the parameters provided from a user through the user interface.

In an aspect of other example embodiments, an apparatus for converting audio signal to haptic signal, the apparatus may include an audio subsystem which is provided with the audio signal from a predetermined application as included within an operating system equipped in the apparatus; an audio-to-haptic converting module extracting perceptive characteristic information of haptic from the audio signal provided from the audio subsystem; and a haptic driver driving a haptic mean based on the perceptive characteristic information of haptic.

Here, the audio-to-haptic converting module may convert the obtained perceptive characteristic information to the perceptive characteristic information after obtaining perceptive characteristic information of the audio signal from the audio signal provided.

In another aspect of other example embodiments, an apparatus for converting audio signal to haptic signal, the apparatus may include a processing part converting audio signal to haptic signal based on perceptive characteristic information of the audio signal of content which is being executed; and a haptic mean which is driven according to the haptic signal provided from the processing part.

Here, the processing part may convert the perceptive characteristic information of haptic to the haptic signal after obtaining perceptive characteristic information from the audio signal of contents which is being executed, and converting the obtained perceptive characteristic information of the audio signal to perceptive characteristic information of the haptic.

Also, the processing part may convert the perceptive characteristic information of the audio signal to the perceptive characteristic information of the haptic by using a pre-defined relation between perceptive characteristic information of audio signal and perceptive characteristic information of haptic.

Here, the apparatus may further include an input-output part presenting a user interface to be provided parameters for adjusting perceptive characteristics of the haptic.

### BRIEF DESCRIPTION OF DRAWINGS

Example embodiments of the present invention will become more apparent by describing in detail example embodiments of the present invention with reference to the accompanying drawings, in which:

FIG. 1 is a flow chart to show a method of converting audio signal to haptic signal according to an example embodiment of the present invention;

FIG. 2 is a conceptual diagram to explain a method of converting audio signal to haptic signal according to an example embodiment of the present invention;

FIG. 3 is a conceptual diagram to explain a procedure of converting perceptive characteristic information of audio signal to perceptive characteristic signal of a haptic effect;

FIG. 4 is a view to show an example embodiment of an user interface display which a haptic adjustment value is inputted by a user in a procedure of converting audio signal to haptic signal;

FIG. 5 is a block diagram to show an apparatus of converting audio signal to haptic signal according to an example embodiment of the present invention;

FIG. 6 is a block diagram to show an apparatus of converting audio signal to haptic signal according to another example embodiment of the present invention; and

FIG. 7 is a block diagram to show an apparatus of converting audio signal to haptic signal according to still other example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, preferred embodiments according to the present invention will be described in detail with reference to the accompanying drawings.

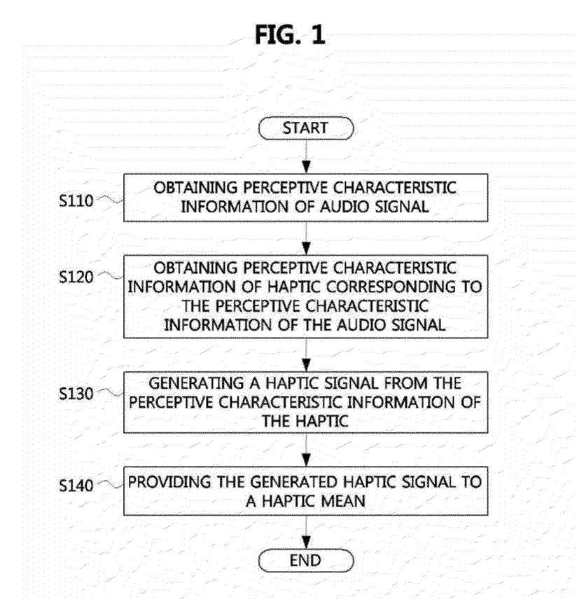

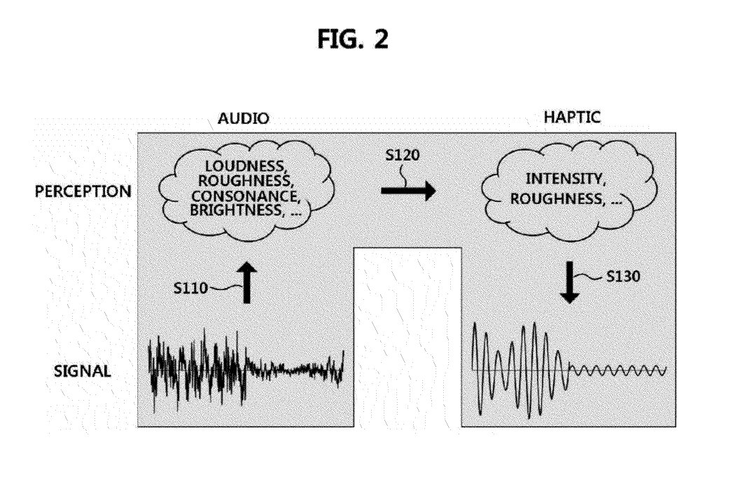

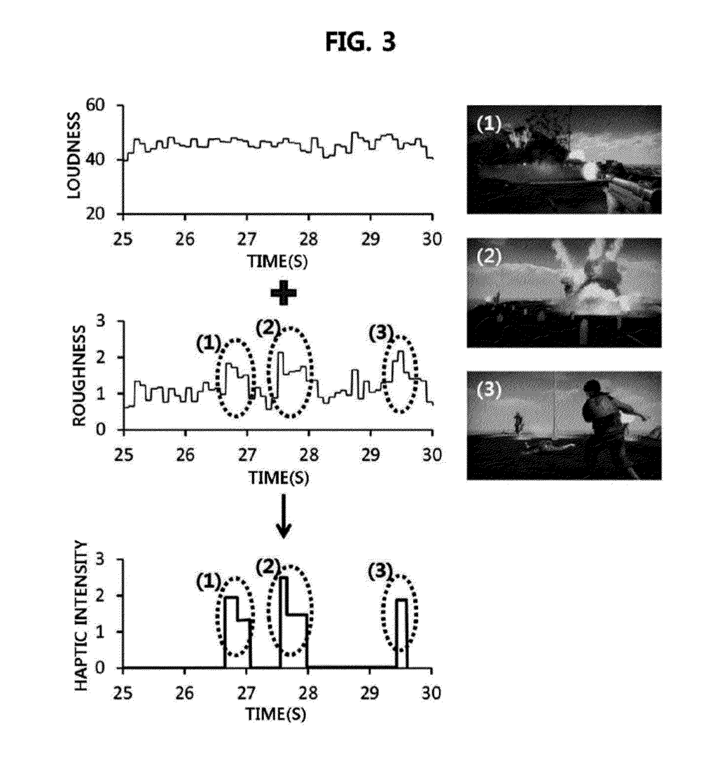

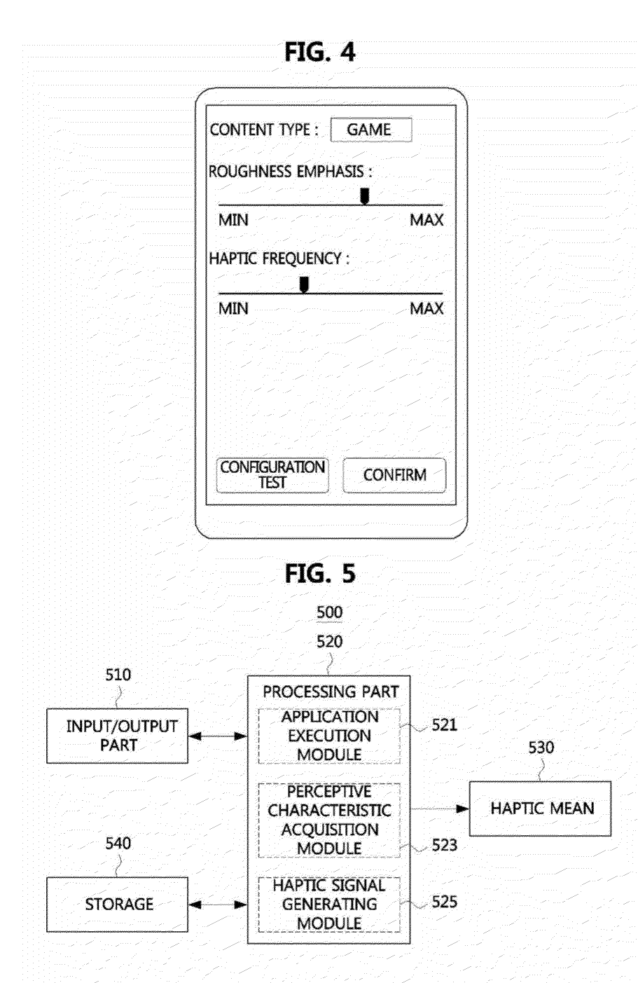

FIG. 1 is a flow chart to show a method of converting audio signal to haptic signal according to an example embodiment of the present invention, and FIG. 2 is a conceptual diagram to explain a method of converting audio signal to haptic signal according to an example embodiment of the present invention. Also, FIG. 3 is a conceptual diagram to explain a procedure of converting perceptive characteristic information of audio signal to perceptive characteristic signal of a haptic effect, and FIG. 4 is a view to show an example embodiment of an user interface display which a haptic adjustment value is provide by a user in a procedure of converting audio signal to haptic signal.

The method of converting audio signal to haptic signal depicted in FIG. 1 and FIG. 2 may be performed by various information process apparatuses equipped with processor and memory. Hereinafter, for a convenient explanation, the method of converting audio signal to haptic signal according to an example embodiment of the present invention is supposed to be performed in a haptic signal converting apparatus equipped with at least one processor and memory.

Referring to FIG. 1 and FIG. 2, the method of converting audio signal to haptic signal according to an example embodiment may include a step of obtaining perceptive characteristic information of the audio signal from the audio signal provided (S110), a step of obtaining perceptive characteristic information of the haptic corresponding to the obtained perceptive characteristic information of the audio signal (S120), a step of generating a haptic signal from the perceptive characteristic information of the haptic (S130), and a step of providing the generated haptic signal to a haptic mean (S140).

First, the step (S110) is a step of obtaining perceptive characteristic information from the audio signal on considering various perceptive characteristics that explain perceptive feelings which human feels from audio signal or haptic stimulus.

For example, humans can explain perceptive characteristics through various feelings such as a loudness of audio signal, a roughness of audio signal, a smoothness of audio signal, a consonance of audio signal, and a brightness of audio signal, when listening to the audio signal. There are various common technologies as methods of obtaining perceptive characteristic information from audio signal. For instance, studies on perceptive loudness of audio were performed so much, an international standard (ISO 266:2003, ‘Equal-Loudness Contours’) has been already established, and there exist many methods of extracting perceptive loudness from audio signal based on those (For example, methods of Glasberg and Moore, or method of Zwicker and Fastl).

Also, methods of calculating roughness of audio signal and degree of dissonance are already known, and there are, as representative methods, methods of Hutchinson and Knopoff or Vassilakis and so on. In addition to the above methods, there exist models and methods for calculating various perceptive values from audio signal.

It is a procedure of calculating perceptive values such as a loudness, a roughness, a smoothness, a consonance, and a brightness to obtain desired perceptive characteristic information from audio signal, and it can be made possible by implementing the common various models as software or hardware.

The step of obtaining perceptive characteristic information of the haptic corresponding to the obtained perceptive characteristic information of the audio signal (S120) is a step of converting perceptive characteristic information of audio signal obtained through the step S110 to corresponding perceptive characteristic information of haptic. In the above-mentioned step, a multimedia producer or a haptic effect producer may design haptic effects according to their intentions. However, the perceptive characteristic information of haptic corresponding to the obtained perceptive characteristic information of the audio signal may be obtained considering only the perceptive characteristics of the audio signal and the haptic, in the method of converting audio signal to haptic signal according to an example embodiment of the present invention. Here, the perceptive characteristic information of the haptic may include, for example, at least one of a loudness, a roughness, a consonance, a brightness and an uniformity.

For example, as shown in (1), (2), (3) of FIG. 3, when a content interworking with haptic signal is a war game and an effect of bomb explosion is desired to be emphasized, we can expect that sound of the explosion has perceptive characteristics that it is much louder and rougher than other effect sounds of neighbor, so that we can design the haptic effect for it to emphasize it. That is, the haptic signal may be designed to include vibrations corresponding to explosion scenes, game scenes (1), (2), (3) depicted in FIG. 3.

The above-described method of designing the haptic signal may be represented as equation 1.

Iₕ=c\sqrt{Lₐ}Rₐ²−o

Rₕ=rRₐ [Equation 1]

In the equation 1, Iₕ represents a perceptive intensity of haptic signal, and Rₕ represents a perceptive roughness of haptic signal. Lₐ represents a perceptive loudness of audio signal, and Rₐ represents a perceptive roughness of audio signal. Also, c, o, and r represent arbitrary constant values which may be adjusted according to a substance of interworking content. By adjusting the constant values, haptic effects may be made a little different to each other.

Here, the constant values (c, o, r) may be configured as various haptic weighting values, and may be configured to adjust haptic effects in detail, by displaying a user interface to the haptic signal converting apparatus as shown is FIG. 4, and receiving specific values for the constant values from a haptic signal designer or the user by the user interface.

Alternatively, the constant values (c, o, r) may be automatically adjusted according to the substance of the interworking content, after optimal values for the constant values are determined through repetitive experiments.

By calculating the perceptive characteristics of haptic signal through the above-explained method, haptic signal corresponding to the perceptive characteristics of audio signal may be obtained accurately.

The method of converting audio signal to haptic signal according to an example embodiment of the present invention has a merit that the procedure of converting audio signal to haptic signal is intuitive, and the haptic signal which is a converted result is easily estimated, by defining human perceptive characteristic on audio signal and perceptive characteristics on haptic mathematically, and generating haptic effects based on the mathematical equations. Also, as shown in the equation 1, the haptic effects may be easily adjusted by a general user in detail properly to the content, by adjusting the constant values (c, o, r) in the procedure of converting the perceptive characteristics of audio signal to the perceptive characteristics of haptic.

Re-referring to FIG. 1 and FIG. 2, in the step of generating a haptic signal from the perceptive characteristic information of the haptic (S130), the haptic signal may be generated from the perceptive characteristic information of the haptic obtained through performing the step (S120).

That is, in the step (S130), the perceptive characteristic information of the haptic may be converted into haptic driving signal to drive a real haptic mean. For example, as shown in the equation 1, the calculated perceptive characteristic information may be converted to a vibration control signal which controls corresponding vibration strength and vibration duration.

In the step of providing the generated haptic signal to a haptic mean (S140), the haptic signal obtained through performing the step (S130) may be provided to the haptic mean. Here, the haptic mean may be configured as a separate apparatus independent to the haptic signal converting apparatus, or may be configured as one of components included in the haptic signal converting apparatus.

The method of converting audio signal to haptic signal shown in FIG. 1 and FIG. 2 may be performed in real time, and may be used for generating the haptic signal automatically by analyzing audio signals on playing multimedia contents, as applied to a mobile terminal, a gaming terminal, a home theater, 4 dimensional movie system and so on.

FIG. 5 is a block diagram to show an apparatus of converting audio signal to haptic signal according to an example embodiment of the present invention.

Referring to FIG. 5, an example embodiment of the haptic signal converting apparatus according to the present invention may include a input/output part 510, a processing part 520, a haptic mean 530, and a storage 540. More specifically, the processing part may include an application execution module 521, a perceptive characteristic acquisition module 523, and a haptic signal generating module 525.

The input/output part may be configured with a keypad and a display device, or a touch screen, and may provide input signals, corresponding to key inputs or touch inputs from the user, to the processing part 520.

Also, the input/output part 510 may represent execution scenes of application or contents provided from the processing part 520, and may represent the user interface screen as shown in FIG. 4 in the procedure of converting audio signal to haptic signal.

The processing part 520 may execute the application or the contents according to input signal indicating execution of the application or the contents, provided from the input/output part 510, and may represent the execution scenes of the application or the content which are being executed via the input/output part 510.

Also, after the processing part 520 obtains the perceptive characteristic information from the application of the contents which are being executed, the processing part 520 may calculate the perceptive characteristic information of haptic corresponding to the obtained perceptive characteristic information of the audio signal, and generate the haptic signal corresponding to the calculated the perceptive characteristic information of haptic.

The processing part 520 may include an application execution module 521, a perceptive characteristic acquisition module 523, and a haptic signal generating module 525.

Specifically, the application execution module 521 may execute the corresponding application (or contents) based on input signal indicating execution of the specific application or the specific contents provided by the input/output part 510, and represent execution scenes of the application being executed to the input/output part 510.

Also, the application execution module 521 may provide audio signal of the application (or contents) being executed to the perceptive characteristic acquisition module 523.

The perceptive characteristic acquisition module 523 may obtain the perceptive characteristic information from the provided audio signal. Here, the perceptive characteristic information of the audio signal may include information on various human feeling, which can be felt by humans in listening to the audio signal, such as a loudness, a roughness, a consonance, and a brightness, and may obtain them by using various common technologies.

Also, the perceptive characteristic acquisition module 523 may convert the obtained perceptive characteristic information of the audio signal to perceptive characteristic information of haptic effect corresponding to the obtained perceptive characteristic information of the audio signal. Here, the perceptive characteristic acquisition module 523 may calculate the perceptive characteristic information of haptic effect based on predefined equations such as the equation 1, may calculate the perceptive characteristic information of haptic effect on considering parameters (for example, constant values of the equation 1) provided by the user via the input/output part 510.

The haptic signal generating module 525 may generate haptic signal corresponding to the perceptive characteristic information of haptic effect provided from the perceptive characteristic acquisition module 523, and provide the generated haptic signal to the haptic mean 530.

The haptic mean 530 is a mean configured to provide haptic effects to the user by being driven according to the haptic signal provided from the processing part 520, and may include at least an actuator. The actuator may be, for example, a vibrator vibrating according to the haptic signal, a motor providing turning forces according to the haptic signal, and at least one driving axle driven by a rotation of the motor.

The storage 540 may be configured to store data of the application or contents being executed in the processing part 520, or may be configured to store instruction codes or data for converting audio signal to haptic signal.

The processing part 520 of components of the haptic signal converting apparatus 500 shown in FIG. 5, may be implemented by a processor, the application execution module 521, the perceptive characteristic acquisition module 523, and the haptic signal generating module 525 may be implemented as a software program, stored in the storage 530, and read out to be executed by the processor to perform respective function of modules.

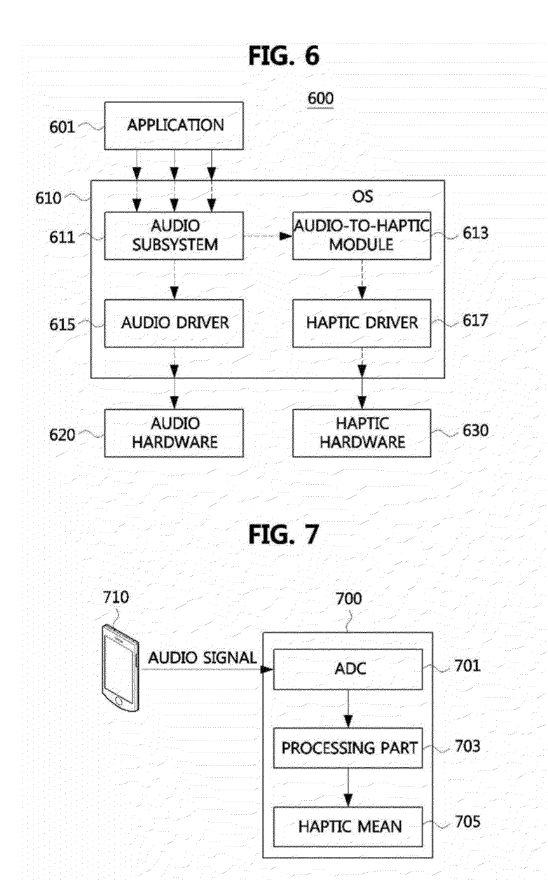

FIG. 6 is a block diagram to show an apparatus of converting audio signal to haptic signal according to another example embodiment of the present invention.

Referring to FIG. 6, another example embodiment of the haptic signal converting apparatus according to the present invention may include an audio subsystem 611 of an operating system (OS) 610 equipped in various information processing apparatuses which can play multimedia and related modules and drivers, so that the apparatus may provide haptic signals according to substances of various kinds of applications 601 or contents (game, movie, music and so on).

That is, the haptic signal converting apparatus 600 may be configured to include the audio subsystem 611, an audio-to-haptic converting module 613, an audio driver 615, and a haptic driver 617. Here, the OS 610 may be configured as, for example, a MS-Windows, a Mac OS X, an Android, an iOS, etc.

The audio subsystem 611 may be provided with audio signal from the various application 601, process the audio signal, and provide the processed audio signal to the audio driver 615 and the audio-to-haptic converting module 613.

The audio driver 615 may transfer the audio signal to various hardware components 620 (for example, a line out port, a headphone port, a speaker and so on), and control a driving of the audio hardware component 620.

The audio-to-haptic converting module 613 may extract the perceptive characteristic information of audio signal from the audio signal provided from the audio subsystem 611, calculate the perceptive characteristic information of haptic corresponding to the extracted perceptive characteristics of audio signal, generate haptic signal corresponding to the perceptive characteristic information of haptic, and provide the generated haptic signal to the haptic driver 617.

The haptic driver 617 may control a driving of the haptic hardware component 630 based on the haptic signal provided from the audio-to-haptic converting module 613. Here, the haptic hardware component 630 may include, for example, at least one vibrator, at least one motor and so on.

FIG. 7 is a block diagram to show an apparatus of converting audio signal to haptic signal according to still other example embodiment of the present invention, and FIG. 7 shows a case that a haptic signal converting apparatus 700 is configured as a separate apparatus independent to the information processing apparatus 710 playing application or contents, and generate haptic signal according to the audio signal provided from the information processing apparatus 710. Here, the information processing apparatus 710 may be one of various apparatuses which can play applications or contents, for example, a computer, a gaming machine, a smartphone, a tablet (pad-type terminal) and so on.

Referring to FIG. 7, a haptic signal converting apparatus 700 according to other example embodiment of the present invention may include an analog to digital converter (ADC) 701, a processing part 703, and a haptic mean 705.

The ADC 701 may be provided with audio signal in analog format from the information processing apparatus 710, convert the provided audio signal in analog to audio signal in digital, and provide the digital audio signal to the processing part 703. Here, the ADC 701 may convert the audio signal in analog to the audio signal in digital by using common signal conversion technologies such as a Pulse Coded Modulation (PCM).

Alternatively, in a case that the haptic signal converting apparatus 700 receives the audio signal in digital format directly from the information processing apparatus 710, the ADC 701 may be included in the haptic signal converting apparatus 700.

Alternatively, in a case that the haptic signal converting apparatus 700 receives audio signal via a wireless interface from the information processing apparatus 710, at least one of wireless communication interface modules, such as a Bluetooth module, an Infrared communication module, an RF communication module and so on, may be included in the haptic signal converting apparatus 700.

The processing part 703 may obtain perceptive characteristic information on the audio signal in digital provided from the ADC (or the information processing apparatus), calculate the perceptive characteristic information of haptic corresponding to the obtained perceptive characteristic information on the audio signal, generate haptic signal corresponding to the perceptive characteristic information of haptic effect, and provide the haptic signal to the haptic mean 705.

The haptic mean 705 is a mean configured to provide haptic effects to the user by being driven according to the haptic signal provided from the processing part 703, and may include at least an actuator. The actuator may be, for example, a vibrator vibrating according to the haptic signal, a motor providing turning forces according to the haptic signal, and at least one driving axle driven by a rotation of the motor.

Alternatively, the information processing apparatus 710 may receive the haptic signal. In a case that the haptic mean, which can provide haptic effects based on the received haptic signal, is equipped in the information processing apparatus 710, the haptic signal converting apparatus may not include the haptic mean 705. In this instance, the processing part 703 may be configured to provide the generated haptic signal to the information processing apparatus 710.

According to the above explained method of converting audio signal to haptic signal, and apparatus performing the same, after perceptive characteristics are extracted from provided audio signal first, perceptive characteristic information of haptic effect according to the perceptive characteristics of the audio signal may be obtained, and the perceptive characteristic information of haptic effect may be converted to haptic signal.

Therefore, the audio signal may be converted to the haptic signal more intuitively and in real time, so that the method and the apparatus may be applied to various fields such as a mobile device, a gaming terminal, a home theater, and a 4 dimensional theater system.

While the example embodiments of the present invention and their advantages have been described in detail, it should be understood that various changes, substitutions and alterations may be made herein without departing from the scope of the invention.

What is claimed is:

1. A method of converting audio signal into haptic signal, performed in a haptic signal converting apparatus, the method comprising:
obtaining perceptive characteristic information of the audio signal from the audio signal provided;
obtaining perceptive characteristic information of the haptic corresponding to the obtained perceptive characteristic information of the audio signal; and
converting the perceptive characteristic information of the haptic to a haptic signal

2. The method of claim 1, wherein the perceptive characteristic information of the audio signal includes at least one of a loudness, a roughness, a smoothness, a consonance, and a brightness.

3. The method of claim 1, wherein the obtaining perceptive characteristic information of the haptic includes defining a relation between the perceptive characteristics of the audio signal and the perceptive characteristics of the haptic; and obtaining the perceptive characteristic information of the haptic corresponding to the perceptive characteristics of the audio signal by using the defined relation.

4. The method of claim 1, wherein the perceptive characteristic information of the haptic includes at least one of an intensity, a roughness, a consonance, a level of the haptic, and an uniformity corresponding to the perceptive characteristic information of the audio signal.

5. The method of claim 1, wherein the perceptive characteristic information of the haptic is characterized by that a user interface for being provided with parameters to adjust perceptive characteristic of the haptic is provided, and the perceptive characteristic information of the haptic is obtained by reflecting the parameters provided from an user through the user interface.

6. An apparatus for converting audio signal to haptic signal, the apparatus comprising:
an audio subsystem which is provided with the audio signal from a predetermined application as included within an operating system equipped in the apparatus;
an audio-to-haptic converting module extracting perceptive characteristic information of haptic from the audio signal provided from the audio subsystem; and
a haptic driver driving a haptic mean based on the perceptive characteristic information of haptic.

7. The apparatus of claim 6, wherein the audio-to-haptic converting module converts the obtained perceptive characteristic information to the perceptive characteristic information after obtaining perceptive characteristic information of the audio signal from the audio signal provided.

8. An apparatus for converting audio signal to haptic signal, the apparatus comprising:
a processing part converting audio signal to haptic signal based on perceptive characteristic information of the audio signal of content which is being executed; and
a haptic mean which is driven according to the haptic signal provided from the processing part.

9. The apparatus of claim 8, wherein the processing part converts the perceptive characteristic information of haptic to the haptic signal after obtaining perceptive characteristic information from the audio signal of contents which is being executed, and converting the obtained perceptive characteristic information of the audio signal to perceptive characteristic information of the haptic.

10. The apparatus of claim 9, wherein the processing part converts the perceptive characteristic information of the audio signal to the perceptive characteristic information of the haptic by using a pre-defined relation between perceptive characteristic information of audio signal and perceptive characteristic information of haptic.

11. The apparatus of claim 8, further includes an input-output part presenting a user interface to be provided parameters for adjusting perceptive characteristics of the haptic.
